(19) United States
(12) Patent Application Publication
(10) Pub. No.: US 2012/0167054 A1
(43) Pub. Date: Jun. 28, 2012

(54) Collecting Program Runtime Information

(75) Inventors: Yan Kai Liu, Beijing (CN); Yao Qi, Beijing (CN); Xing Xing Shen, Beijing (CN); Chuang Tang, Beijing (CN)

(73) Assignee: International Business Machines Corporation, Armonk, NY (US)

(21) Appl. No.: 13/413,181

(22) Filed: Mar. 6, 2012

Related U.S. Application Data
(63) Continuation of application No. 12/913,635, filed on Oct. 27, 2010.

(30) Foreign Application Priority Data
Oct. 30, 2009 (CN) 200910211315.X

(51) Int. Cl. G06F 9/44; G06F 11/30

(52) U.S. Cl. 717/125; 717/126

(57) ABSTRACT

System(s), method(s), and computer program product(s) for collecting program runtime information are provided. In one aspect, this comprises: an instrumentation module for inserting, by program instrumentation, monitoring code into the constructor of an exception class in a program to run; and a monitoring module implemented by said monitoring code, the monitoring module for collecting program runtime information during the running process of the program. In another aspect, this comprises: obtaining verification point variables from assertions for a program to be tested; inserting monitoring code into positions in the program that access the obtained verification point variables; and as the program runs, collecting runtime information of the program by the inserted monitoring code.

### BACKGROUND

The present invention relates to the computer field, particularly to the testing of computer software, and more particularly, to collecting program runtime information.

Functional verification testing (also called black-box testing) refers to testers testing a program/system without knowing the internal implementation of the program. Testers only know the information of the input data and the observed output results, but they have no idea how the program or system works.

During the testing, when a test case is executed, if a defect is found, it needs to be opened for developers, which usually includes: 1) describing the steps to re-create the defect; 2) if there is an error log, the error log information for the defect is extracted from the log; 3) saving a snapshot; 4) sending all the above information to developers by using a defect tracking and reporting tool, such as Rational ClearQuest®. (“ClearQuest” is a registered trademark of International Business Machines Corporation in the United States, other countries, or both.)

Since the process of conventional functional verification testing is black-box testing, testers have no means to analyze the source code to learn about the internal logic of the program under test, and can only understand and analyze externally. Therefore, sometimes it is very difficult for the testers to determine whether a defect is caused by environmental reasons or is a real defect, which may make the testers often open invalid defects, thus wasting the time of both testers and developers. It is also hard for testers to locate the code causing errors, and thus they are unable to analyze the errors and provide more useful information to developers. When the defect description information is neither accurate nor detailed, it is hard for developers to communicate with testers. For multinational enterprises, developers and testers are usually cross-regions and cross-time-zones, and thus cannot communicate instantly or freely on defects, which further increases the difficulty of communication.

Although in some circumstances, the program under test will throw exceptions and record them in an error log (e.g., SystemOut.log of a WebSphere® application server), such that testers or developers can locate the error position according to the information in the error log, in many cases, programs under test do not generate a log. In some other cases, the generated log is not accurate. (“WebSphere” is a registered trademark of International Business Machines Corporation in the United States, other countries, or both.)

Furthermore, as a tester, he/she cannot and should not install a set of development environment to debug errors of a program and obtain the detailed information on the errors, as a developer does. Moreover, for some server applications, those server applications need to run and process concurrent requests from other clients at the same time of testing, while debugging the programs makes the application servers unable to simultaneously run and process the requests from other clients.

In addition, although some testers register source code version management tools, such as CVS (Concurrent Versions System), to check and analyze source code, it is merely a static analysis and can not get or observe the real-time running condition of the program. And such a method is forbidden in some projects since it may involve security problems.

### BRIEF SUMMARY

In an aspect of the present invention, there is provided a method for collecting program runtime information, comprising: inserting, by program instrumentation, monitoring code into the constructor of an exception class in a program to run; and collecting the runtime information of the program by the monitoring code during the running process of the program.

In another aspect of the present invention, there is provided a system for collecting program runtime information, comprising: an instrumentation module for inserting, by program instrumentation, monitoring code into the constructor of an exception class in a program to run; and a monitoring module implemented by the monitoring code, for collecting the runtime information of the program during the running process of the program.

In yet another aspect, the present invention comprises: parsing, in a test case used for testing a program, assertions to obtain verification point variables referenced in the assertions; inserting, by program instrumentation, monitoring code into positions in the program that access the obtained verification point variables; and during a running process of the program, collecting runtime information of the program by the inserted monitoring code.

An embodiment of the present invention can provide more detailed and accurate information to testers when errors occur during the running process of the program under test, including the call stack and parameter values when the errors occur, to make the testers better open defects for developers, so that developers can better understand the context and cause of the program defect, locate the errors, and overcome the program defect more rapidly. In addition, all these can be done in the original testing environment, and do not require the testers to install extra development and debugging tools. Moreover, for programs running on a server, the programs can process requests from other clients while performing the testing without interrupting services.

### BRIEF DESCRIPTION OF THE SEVERAL VIEWS OF THE DRAWINGS

The appended claims set forth the inventive features which are considered characteristic of the present invention. However, the invention itself and its preferred embodiments, objects, features, and advantages will be better understood by referring to the following detailed description of exemplary embodiments, when read in conjunction with the accompanying drawings, in which:

FIG. 1 illustrates the architecture of a system for collecting and providing diagnosis information during a functional verification testing according to an embodiment of the present invention;

FIG. 2 describes a method for collecting and providing diagnosis information during a functional verification testing according to an embodiment of the present invention;

FIG. 3 depicts a user interface for inputting user information in a specific exemplary scenario;

FIG. 4 depicts a user interface for viewing user information in the specific exemplary scenario;

FIG. 5 shows a user interface for displaying call stack information and corresponding source code information in the specific exemplary scenario.

### DETAILED DESCRIPTION

Embodiments of the present invention will be described with reference to the accompanying drawings. In the following description, numerous details are described to make the present invention fully understood. However, it is obvious to those skilled in the art that the implementation of the present invention can exclude some of these details. In addition, it should be appreciated that the present invention is not limited to the described specific embodiments. In contrast, it is contemplated to implement the present invention by using any combination of the following features and elements, no matter whether they involve different embodiments or not. Therefore, the following aspects, features, embodiments, and advantages are only illustrative, rather than elements or limitations of the appended claims, unless explicitly stated otherwise in the claims.

The basic idea of the present invention is to collect and provide accurate diagnosis information when a program is running during the process of a functional testing, so as for the tester to open defects.

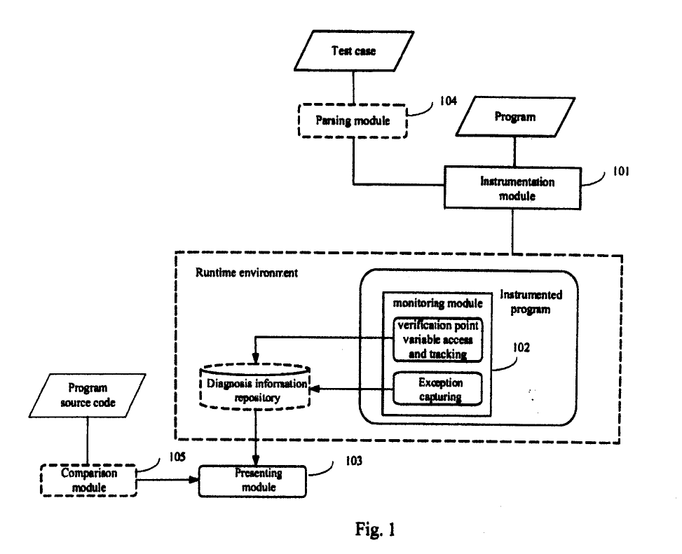

FIG. 1 illustrates the architecture of a system for collecting and providing diagnosis information during a functional verification testing according to an embodiment of the present invention. As shown, the system comprises: an instrumentation module 101 for inserting, by program instrumentation, monitoring code into a program under test, for collecting runtime information of the program under test; a monitoring module 102 implemented by the monitoring code, for collecting the runtime information of the program under test during the test running process of the program under test; and an optional presenting module 103 for presenting the runtime information related to a program defect to the tester.

The instrumentation module 101 can be realized by any instrumentation tools known in the art. As known by those skilled in the art, instrumentation refers to inserting, in source code, execution code, or some intermediate code of a program, extra monitoring code to extract information during the running process of the program. For example, the monitoring code can be inserted into the beginning and end positions of a method, such that during the running time, when a thread enters the method, it can record and report the name of the method called by the thread as well as the parameter information of the method. As another example, the monitoring code can be inserted around instructions for reading or writing fields of objects or classes in the heap, so as to record information such as the owner class/object information, field information, operation type information, etc., of the current memory operation.

In the prior art, instrumentation is usually applied in coverage analysis of programs, and is not for collecting diagnosis information during the functional verification testing so as to open defects. For the first time, the present invention applies the program instrumentation technology in the functional verification testing of programs to collect runtime information related to program defects during the running process of the program.

According to an embodiment of the present invention, the program under test is a Java® program, and the instrumentation is a bytecode instrumentation, that is, inserting extra monitoring code into a specific position in a Java class to extract information during the class execution process. (“Java” is a registered trademark of Sun Microsystems, Inc. in the United States, other countries, or both.)

The monitoring module 102 in the system according to an embodiment of the present invention is implemented by the monitoring code inserted into the program under test.

According to an embodiment of the present invention, in order to track the error point in the running process of the program under test, any one or two of the following two instrumentations are performed:

1) Instrumentation for capturing exceptions. During the running process of the program, an exception may be thrown, indicating the program has an exception. The position throwing the exception is usually the error position. When the exception happens, an exception object will be constructed. By performing instrumentation to the constructor of the exception object, the error position will be captured. Therefore, for such an error, the system according to the embodiment of the present invention performs instrumentation to the constructor of the exception class. For example, when an exception occurs, code similar to the following will appear.

Exception e=new SomeException( );

By modifying the constructor of the class Exception, and inserting monitoring code therein for recording related information when the program is running, program runtime information such as the error position when the exception is thrown, etc., can be captured. Since the Exception class is the parent class of all the exception classes, the construction of all the exception classes will call the Exception class. Consider the following Java code, as an example:

```
public class Exception extends Throwable {
  public Exception( ) {
    super( );
  }
```

The modified Exception class becomes:

```
public class Exception extends Throwable {
  public Exception( ) {
    super( );
    runtimeRecorder.recordExceptionWithThreadStack (this);
  }
```

As shown by the above code segments, at the end of the Exception class constructor, a new method call, recordExceptionWithThreadStack (Exception e), is inserted by the bytecode instrumentation technology and the inserted method is used for recording the exception construction and the call stack information of the current thread or all the threads when the exception is constructed. An example of the inserted method is as follows:

recordExceptionWithThreadStack (Exception e) {
//step 1: record the exception e
//step 2: record the call stack of the current thread or all the threads during
// running
}

In such an instrumentation method, whenever an exception is thrown during the running process of the program under test, the monitoring code will record the program runtime information (e.g., information of the call stack, etc.) when the exception happens, in a diagnosis information repository, for example, for the presenting module 103 to present it to the tester. Of course, the monitoring code can also directly present the program runtime information when the exception happens to the presenting module 103, so that the presenting module 103 presents it to the tester.

In the conventional exception capturing method, instrumentation is all performed to exception processing parts so as to capture the program exception in the exception processing parts. However, since the exception processing parts are dispersed all over the program, all the exception processing parts need to be modified, which is not only tedious, but more severely, some exceptions do not need to be processed explicitly, thus some exceptions cannot be captured in the exception processing parts. The system according to an embodiment of the present invention only performs instrumentation to the constructor of exceptions, which not only reduces the work load significantly, but also captures effectively all the exceptions produced during program running.

As known by those skilled in the art, the call stack information includes the current thread identifier of the program under test running at the current time, as well as the names of a series of called classes and methods, and input and output parameter information. By the call stack information, the current program runtime state and the error position can be obtained.

2) Instrumentation for assertion variables. In the functional verification testing, the test case will use an assertion to determine the program execution result, that is, setting a verification point variable and its expected value. If the value of the verification point variable after the program under test runs is consistent with the expected value, it is determined that the testing is correct, and the assertion passes; otherwise, it is determined that the testing is wrong, and the assertion fails. According to an embodiment of the present invention, before the testing is performed, the assertions in the test case are parsed to get the verification point variables. Then, all the positions accessing the verification point variables in the program under test (including each read access or write access to the verification point variables) are instrumented to insert the monitor code so as to record related information when the program under test runs.

In such an instrumentation method, whenever the program under test accesses a verification point during the running process, the monitoring code will record the runtime information (e.g., the current call stack information, etc.) when the program under test accesses the verification point, and the value of the verification point variable when it accesses the verification point variable (e.g., recording in a diagnosis information repository), or directly provide them to the testing tool. The testing tool can determine whether the assertion in the test case is successful by analyzing the recorded or provided information. In response to determining that the assertion fails, the testing tool can use the presenting module 103 to provide the program runtime information at the time of verification point access that causes the assertion failure and the value of the verification point variable to the tester.

According to an embodiment of the present invention, the system further comprises an optional parsing module 104 for parsing the assertions in the test case to get the verification point variables therein so as to perform the corresponding instrumentation. Of course, the assertions in the test case can be parsed artificially to get the verification point variables therein.

For example, consider the following test case:

##################################################

| | |
|---|---|
| ## TESTCASE NAME | : test_savingsaccount.script |
| ## VERSION | : %W% - %E% |
| ## LINE ITEM | : PythonArrays |
| ## COMPONENT(S) | : DBOP |

Print “TestCase Start”
......
declare accountSum long; ----variable declaration
......
DepositMoney(accountSum, 100) ----variable access 1
......
WithdrawMoney(accountSum, 20) ----variable access 2
......
Assert(accountSum =80) ----assertion ,determining whether the value
of the variable satisfies the assertion
......

By parsing the test script, the verification point variable accountSum can be identified and registered to the following verification point variable table together with its access point (that is, the statements accessing the verification point variable):

| Verification point variable | Variable access point |
|---|---|
| OperationTimes | RegOper(,,), |
| | CheckOper(,,), |
| | RevkOper(,...,) |
| . . . | . . . |
| accountSum | DepositMoney(parm1), |
| | WithdrawMoney(parm1)... |
| . . . | . . . |

Then, for the verification point variable accountSum, by reading the positions where the access point appears according to the variable table, the instrumentation model 101 can automatically perform bytecode instrumentation to the program under test, so as to monitor every access to the variable.

For example, consider the following exemplary Java program segment:

```
class OperateAccount
{
    int accountSum;
    public void DepositMoney (int sum, int change)
    {
        this. accountSum = this. accountSum + change;
        sum = this. accountSum;
    }
public void WithdrawMoney (int sum, int change)
    {
        this. accountSum = this. accountSum − change;
        sum = this. accountSum;
    }
}
```

The instrumented program segment is:

```
class OperateAccount
{
    int accountSum;
    public void DepositMoney (int sum, int change)
    {
        this. accountSum = this. accountSum + change;
        sum = this. accountSum;
        runtimeRecorder.recordWrite (this, sum);
    }
public void WithdrawMoney (int sum, int change)
    {
        this. accountSum = this. accountSum − change;
        sum = this. accountSum;
      runtimeRecorder.recordWrite (this, sum);
    }
}
```

In this instrumented program segment, runtimeRecorder.recordWrite( ) is the monitoring code inserted into the program for monitoring the accesses to the verification point variable.

Thus, while test case begins to be executed, the program under test starts to run. During the running process of the program under test, by the monitoring code, every access of every verification point variable is monitored and recorded. The recorded information may be stored, e.g., in a verification point variable access history table of the diagnosis information repository. For each verification point variable, the recorded and stored runtime information may include: the current value of the variable, the current context of the variable, e.g., the current call stack, and values of the input and output parameters in the call stack. The current state of the verification point can be known by this information to determine whether the access process of the verification point is correct, so that when the test case has a verification point verification error (i.e., the assertion fails), the internal reason of the error in the program can be identified and related information can be provided.

According to another embodiment of the present invention, the system further comprises an optional comparison module 105 for comparing the runtime information related to the program defect collected by the monitoring module 102 with the source code of the program to determine source code related to the program defect, and presenting the source code to the tester by the presenting module 103, so that the tester can precisely locate the position of the program defect in the source code. For example, the comparison module 105 may first obtain the program source code package, then find out the corresponding source code in the program source code package according to the class names, the method names, and the row numbers returned by the monitoring module 102, and display them by the presenting module 103.

After getting the runtime information related to the program defect recorded or provided by the monitoring module 102, the presenting module 103 may first analyze, select, or process the information, then present the analyzed, selected, or processed information to the tester, or may provide directly the obtained information related to the program defect recorded or provided by the monitoring module 102 to the tester to be analyzed and processed, so as to open the defect to developers.

The system of the present invention can be applied to testing of stand-alone programs, or can be applied to testing of programs running in the client-server mode. When it is applied to a program running in the client-server mode, the monitoring module 102 in the system of the present invention runs on the server together with the program under test, while other modules in the system of the present invention, including the instrumentation module 101, presenting module 103, comparison module 105, can all run on the client.

The system of the present invention is especially suitable for obtaining the diagnosis information of a program under test running in the client-server mode. In such a client-server mode, the program runs on the server, and can receive and process a plurality of concurrent connection requests. Using the conventional debugging method, developers need to initiate the program and enter into the debugging mode, thus monopolizing the server, thus they can not support other concurrent connections, which greatly affects users' use experience, and thus is not acceptable. However, with the system of the present invention, since the operation of the program under test is not affected after the instrumentation, the concurrent operation of a plurality of connections can be supported while obtaining various runtime information, and the usability of the program under test will not be affected, so that a better user experience can be provided.

Above is described the system for collecting and providing diagnosis information in functional verification testing according to embodiments of the present invention. It should be pointed out that the above description and illustration are only exemplary, not limiting, to the present invention. In other embodiments of the present invention, the system may have more, less, or different modules, and the relationships between the respective modules can be different from that which is described.

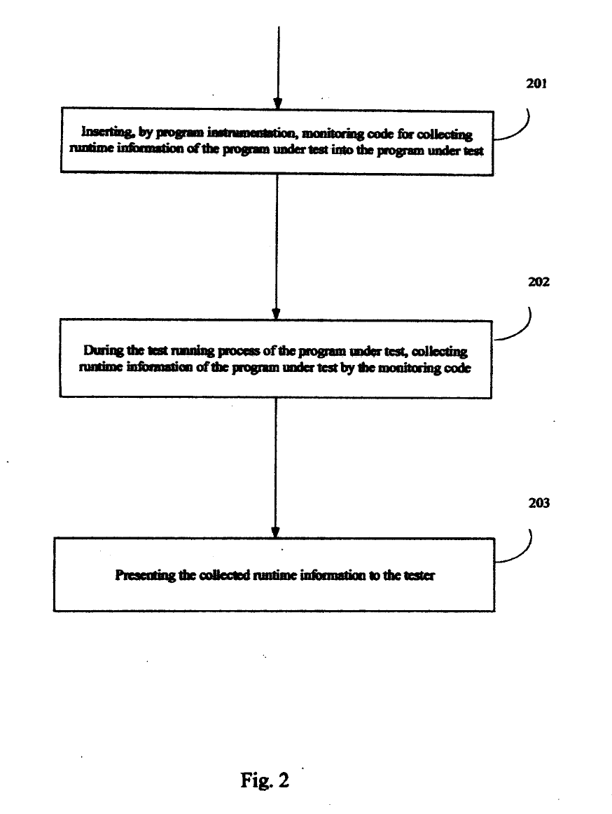

In another aspect of the present invention, there is provided a method for collecting and providing diagnosis information in a functional verification testing. In the following, the method for collecting and providing diagnosis information in the functional verification testing according to an embodiment of the present invention will be described by referring to FIG. 2. The method can be executed by the system for collecting and providing diagnosis information in the functional verification testing according to an embodiment of the present invention described above. For simplicity, some of the details redundant with the above description are omitted in the following description, and thus a more detailed understanding of the method of the present invention can be obtained by reference to the above description.

As shown, the method includes the following:

In Block 201, monitoring code for collecting the runtime information of the program under test is inserted into the program under test by program instrumentation.

In Block 202, during the test running process of the program under test, the runtime information of the program under test is collected by the monitoring code.

In Block 203, the collected runtime information is presented to the tester.

According to an embodiment of the present invention, the monitoring code is inserted into the constructor of an exception class, for collecting the runtime information when the program under test creates the exception during the test running process.

According to an embodiment of the present invention, the method further comprises the following optional steps: obtaining verification point variables in a test case by parsing assertions in the test case; and wherein the monitoring code is inserted into positions accessing the verification point variables in the program under test for collecting the runtime information when the program accesses the verification points during the test running process and also for collecting the values of the verification point variables.

According to an embodiment of the present invention, presenting the runtime information related to the program defect to the tester comprises: in response to determining an assertion failure according to the value of a verification point variable, providing to the tester the runtime information of the program under test when accessing the verification point during the testing operation process.

According to an embodiment of the present invention, the runtime information comprises the call stack information during the operation of the program under test.

According to an embodiment of the present invention, the method further comprises the following optional processing: determining the source code related to the program defect by comparing the runtime information related to the program defect with the source code of the program; and presenting the related source code to the tester.

The working process of the system of the present application will be illustrated below by a specific exemplary application scenario. In the application scenario, the tester, in order to test the function of creating a user account of a portal application, attempts to create a user account through the portal, and the information of the user is stored in a database after it is submitted. Before the testing, the tester has performed instrumentation to the portal application by inserting monitoring code in the verification point positions of the portal application and the constructor of an exception class.

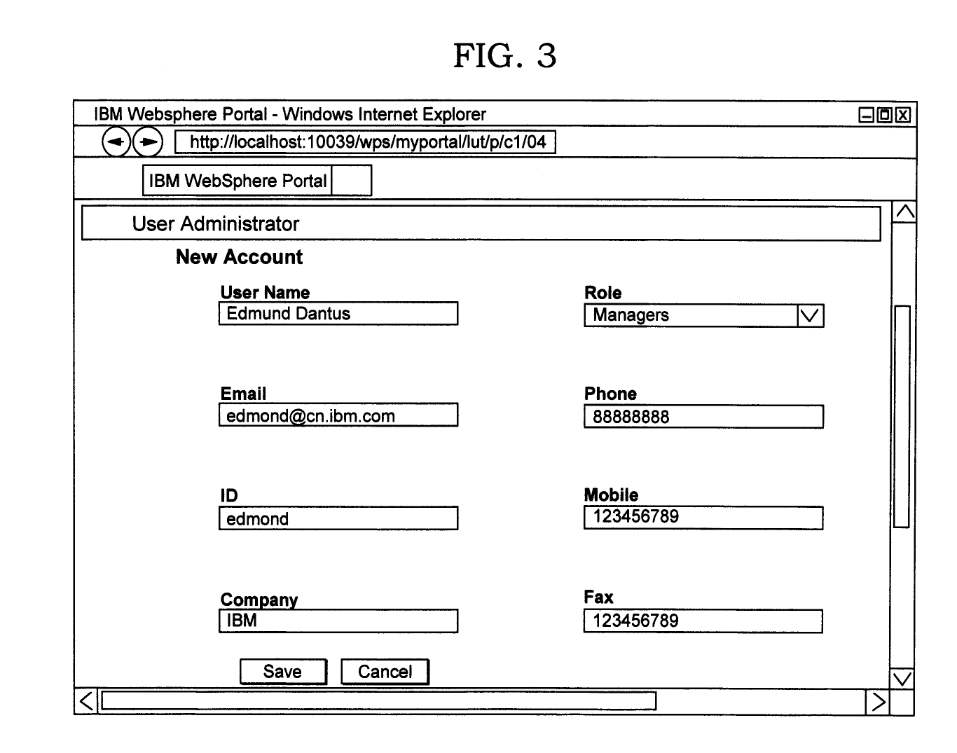

During the testing process, the tester opens the portal to enter the page for creating a user account, inputs user information, and submits it. FIG. 3 shows a user interface for inputting user information in the specific exemplary application scenario. As shown, in the user interface, the tester inputs information of the user name, role, E-mail address, telephone number, ID, mobile telephone number, company name, and fax number, and presses the save button to store the input information in the database. In this example, the user name is Edmond Dantus, and his role is Managers.

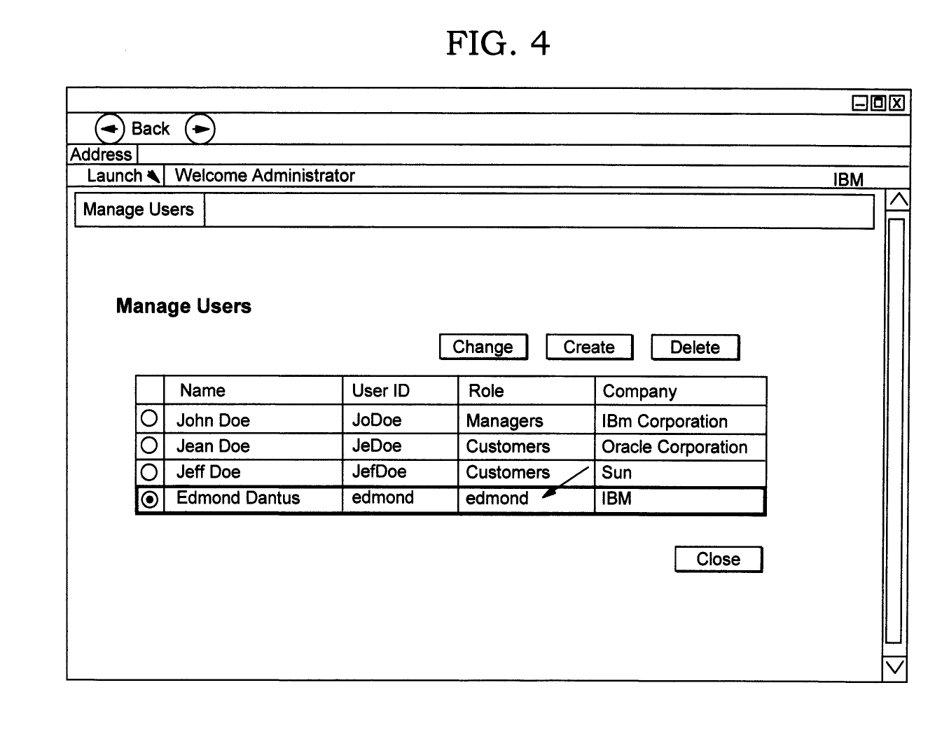

After the tester successfully creates the user account, in another user interface he finds that the user's role information is not correct, in that it is not the initially input information. FIG. 4 shows a user interface for viewing the user information in the specific exemplary application scenario, showing that the role of the user Edmond Dantus is edmond, which is inconsistent with the information input by the tester as shown in FIG. 3.

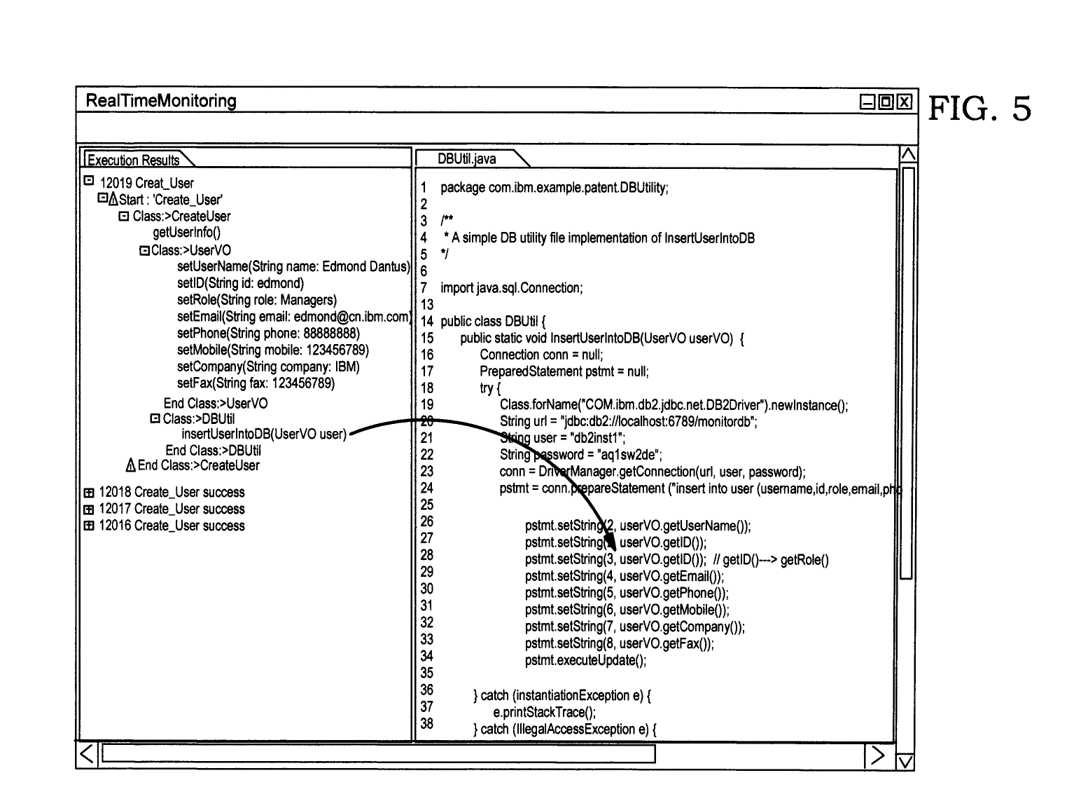

The tester obtains and displays related call stack information and corresponding source code information through the system according to an embodiment of the present invention. FIG. 5 shows a user interface for displaying the call stack information and the corresponding source code information in the specific exemplary application scenario, wherein the left side in the Figure is the call stack information, and the right side is the corresponding source code information. Through the presented call stack information and source code information, the tester can easily locate the source code position where the error happens.

In addition, it should be pointed out that the method and system for performing instrumentation to the constructor of an exception proposed by the present invention can not only be applied to the functional verification testing of programs, but also to other cases, so as to collect related runtime information when an exception happens during the running process of the program. Therefore, in another aspect of the present invention, there is provided a method for collecting program runtime information, comprising: inserting monitoring code, by program instrumentation, into the constructor of an exception class in the program to run; and during the running process of the program, collecting runtime information of the program by the monitoring code. Moreover, in yet another aspect of the present invention, there is also provided a system for collecting program runtime information, comprising: an instrumentation module for inserting, by program instrumentation, monitoring code into the constructor of an exception class in the program to run; and a monitoring module implemented by the monitoring code, for collecting runtime information of the program during the running process of the program.

The present invention can be realized by hardware, software, or a combination thereof. The present invention can be implemented in a single computer system in a centralized manner, or in a distributed manner in which different components are distributed in several inter-connected computer systems. Any computer system or other devices suitable for executing the method described herein are appropriate. A typical combination of hardware and software can be a general-purpose computer system with a computer program, which when being loaded and executed, controls the computer system to execute the method of the present invention and constitutes the apparatus of the present invention.

The present invention can also be embodied in a computer program product, which includes all the features that enable realizing the method(s) described herein, and when loaded into a computer system, can execute the method.

Although the present invention has been illustrated and described with reference to the preferred embodiments, those skilled in the art should appreciate that various changes both in form and details can be made thereto without departing from the spirit and scope of the present invention.

1. A computer-implemented method for collecting program runtime information, comprising:
inserting, by program instrumentation, monitoring code into a constructor of an exception class in a program to run; and
during a running process of the program, collecting runtime information of the program by said monitoring code.

2. The method of claim 1, further comprising:
presenting the collected runtime information on a user interface.

3. The method of claim 2, wherein the method is used for functional verification testing of the program, and further comprises:
obtaining verification point variables in a test case usable for testing the program by parsing assertions in the test case;
inserting, by program instrumentation, monitoring code into positions in the program that access the obtained verification point variables.

4. The method of claim 3, wherein presenting the collected runtime information comprises:
in response to determining an assertion failure according to a value of a selected one of the obtained verification point variables, presenting, on the user interface, the collected runtime information when the program accesses a verification point that corresponds to the selected verification point variable during the running process and the value of the verification point variable.

5. The method of claim 1, wherein said runtime information of the program comprises call stack information of a current thread in the running process of the program.

6. The method of claim 1, wherein said runtime information of the program comprises call stack information of all threads in the running process of the program.

7. The method of claim 1, further comprising:
determining source code related to a program defect by comparing the collected runtime information with source code of the program; and
presenting, on a user interface, said source code related to the program defect.
